(19) United States
(12) Patent Application Publication
(10) Pub. No.: US 2007/0220998 A1
(43) Pub. Date: Sep. 27, 2007

(54) Actuators

(75) Inventor: Joseph Thomas Kopecek, Santa Clarita, CA (US)

Correspondence Address: FOLEY AND LARDNER LLP;SUITE 500, 3000 K STREET NW, WASHINGTON, DC, 20007, US

(73) Assignee: Smiths Aerospace LLC

(21) Appl. No.: 11/713,631

(22) Filed: Mar. 5, 2007

(30) Foreign Application Priority Data
Mar. 7, 2006 (GB) 0604520.7

(51) Int. Cl. F16H 27/02

(52) U.S. Cl. 74/89.39; 74/89.38

(57) ABSTRACT

An actuator has an output ram driven to extend and retract by a rotating lead screw. The lead screw is coupled with a rotating input shaft via a lost-motion drive sleeve connected with the input shaft by cooperating threads so that rotation of the drive shaft causes both axial and rotational movement of the drive sleeve. The ram is locked in its retracted position by several radially-extending locking keys, one end of which engage an extension sleeve fixed with the ram and the other end of which are engaged by a lock sleeve. Rotation of the input shaft causes the drive sleeve to move axially and engage the lock sleeve, thereby pulling it to one side and allowing the locking keys to move radially out and disengage the extension sleeve to allow it to extend.

### BACKGROUND OF THE INVENTION

This invention relates to actuators.

The invention is more particularly concerned with linear actuators that can be locked in position.

Conventional linear actuators may be driven from a rotary source such as an electric, hydraulic or pneumatic motor. The actuator includes a mechanism to convert the rotary motion from the motor to a linear output motion to translate an external load. The actuator may have a lock mechanism to retain the output ram in a fixed position, usually a retracted position, until power is applied to extend the ram. The lock is sequentially actuated to an unlocked state before the torque necessary to deploy the ram is applied. This is typically accomplished by a solenoid or electric motor mechanically linked to the lock mechanism and is separate from the drive motor that actuates the load. The use of a separate lock driver actuator increases the cost and complexity of the actuator. Separate dedicated actuation commands and logic devices are needed to control the lock. Furthermore, electrical wiring, linkage or hydraulic tubing is required to transmit the commands to actuate the lock. An important disadvantage in aerospace applications is the weight associated with the independent lock actuation and the equipment required to support it. An example of a previous linear actuator is described in U.S. Pat. No. 5,960,626.

### BRIEF SUMMARY OF THE INVENTION

It is an object of the present invention to provide an alternative actuator.

According to one aspect of the present invention there is provided an actuator including a rotary input member, a linear output member and a mechanism for converting rotary motion of the input member to linear motion of the output member, the actuator including a lock member displaceable from a first position in locking engagement with the linear output member to a second position out of locking engagement, and the lock member being retained in the first position until there is rotary motion of the input member.

The lock member is preferably displaceable radially. The lock member may be retained in the first position by a second member and the second member may be displaceable axially in response to rotation of the input member. The lock member and linear output member may have cooperating inclined surfaces such that linear movement of the output member applies a radial force to the lock member. The mechanism for converting rotary motion to linear motion includes a lead screw and nut mechanism. The rotary input member is preferably coupled with the lead screw by a lost-motion coaxial drive sleeve, and the drive sleeve preferably connects with the input member by cooperating threads on the input member and the drive sleeve such that rotation of the input member initially causes axial displacement of the drive sleeve before it causes rotation of the drive sleeve and of the lead screw. The drive sleeve may cooperate with a separate, axially-displaceable lock sleeve to effect axial displacement of the lock sleeve when the drive sleeve is displaced axially. The lock sleeve may have an inner surface arranged to engage one end of a radially-displaceable lock member such as to enable or prevent displacement of the lock member.

According to another aspect of the present invention there is provided an actuator including a rotary input member, a linear output member and a mechanism for converting rotary motion of the input member to linear motion of the output member, the actuator being arranged to lock the linear output member in a fixed position until there is rotary motion of the input member.

According to a further aspect of the present invention there is provided an actuator including a rotary input member, a linear output member and a mechanism for converting rotary motion of the input member to linear motion of the output member, the actuator being arranged to displace a lock mechanism from a locking to a release state when rotary motion is applied to the input member.

A linear actuator, for use in aircraft actuation systems, according to the present invention will now be described, by way of example, with reference to the accompanying drawings.

### BRIEF DESCRIPTION OF THE DRAWINGS

FIG. 1 is a view of the exterior of the actuator in a locked, stowed state;

FIG. 2 is a sectional side elevation view of a part of the actuator in a locked, stowed state, to a larger scale;

FIG. 3 is a sectional side elevation view of the actuator when drive is applied initially to unlock the ram but prior to extension of the ram;

FIGS. 4 and 4A are sectional side elevation views of the actuator as the ram begins to be extended while the lock keys are driven outwardly, with FIG. 4A being an enlarged detail of FIG. 4;

FIGS. 5 and 5A show the actuator more fully extended with the lock keys driven fully out as the ram continues to a fully deployed position, with FIG. 5A being an enlarged detail of FIG. 5;

FIGS. 6, 6A and 6B are a sectional side elevation views of the actuator with the ram extended and where drive is applied to stow the ram, with FIGS. 6A and 6B being enlarged views of different parts of FIG. 6; and

FIGS. 7 and 7A are sectional side elevation views of the actuator as the ram arrives at the stowed position and the lock sleeve drives the lock keys inwardly into the ram groove, with FIG. 7A being an enlarged detail of FIG. 7.

### DETAILED DESCRIPTION OF THE PREFERRED EMBODIMENT

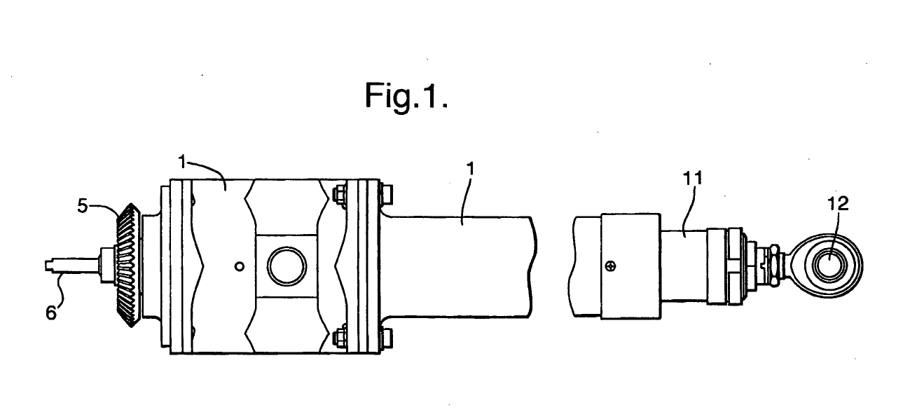

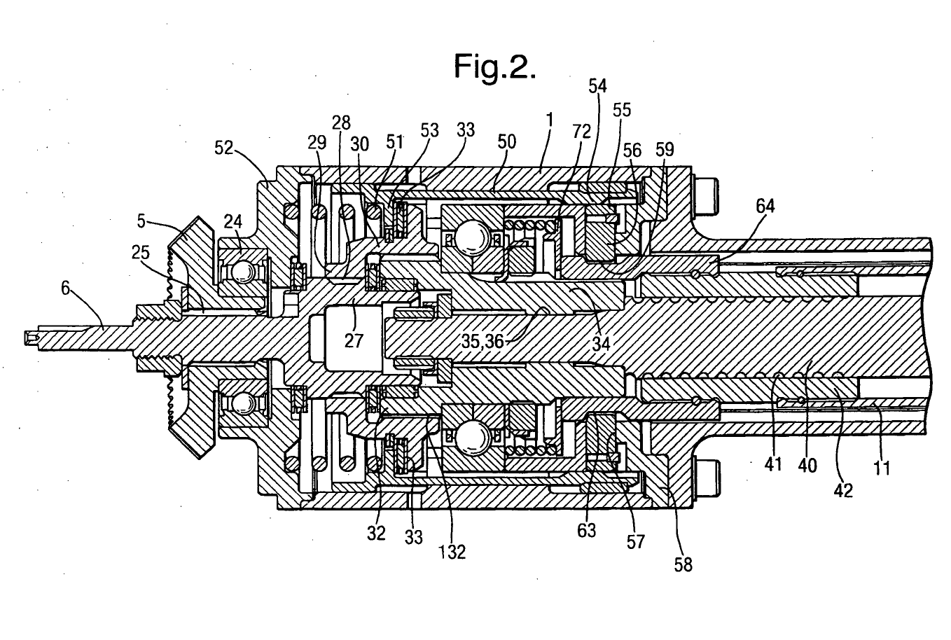

With reference first to FIGS. 1 and 2, the actuator has an outer casing 1 of generally cylindrical shape and is supported approximately midway along its length by two gimbals for pivoting movement about an axis at right angles to the length of the casing. At the left-hand end of the casing 1, on one side, there is an input drive connection 5 in the form of a bevel gear mounted to the axial drive shaft 6. A lead screw and nut mechanism indicated by the numeral 40 and 42 converts the rotary motion of the axial drive shaft 6 into linear motion of a generally cylindrical ram member 11 so that this is extended out of or retracted into the right-hand end of the casing 1. The ram member 11 has an eye 12 at its far end to which a member to be displaced, such as a door or panel, is attached. When the ram member 11 is fully retracted into the casing 1 it is locked in the retracted position by the mechanism until a rotary drive is applied by via the bevel gear 5 to extend the ram.

The bevel gear 5 is supported in the casing 1 by a bearing 24. The bevel gear 5 has an internally-splined sleeve 25 extending coaxially around an externally splined region located midway along an axial drive shaft 6. The right-hand end of the drive shaft 6 is enlarged radially, is hollow and open at its end, providing a cylindrical portion 27. On its external surface, the cylindrical portion 27 is cut with an Acme, helical thread lead screw 28. The Acme thread 28 is engaged by an internally-threaded collar 29 at the rear, left-hand end of a lost motion coaxial drive sleeve 30. The forward, right-hand end of the drive sleeve 30 supports on its outside surface a radially-extending thrust bearing 33, the purpose of which will be explained later.

The forward, right-hand end of the drive sleeve 30 is also internally splined and engages splines 132 on the outside of the rear end of a tubular output shaft 32. At its right-hand, forward end 34 the output shaft 32 has internal splines 35, which engage external splines 36 towards the rear, left-hand end of a ball screw shaft 40. It can be seen, therefore, that rotation of the first bevel gear 5 is transferred via the drive shaft 6, the drive sleeve 30 and the output shaft 32 to cause rotation of the ball nut shaft 40.

The ball screw shaft 40 has an external thread 41 in which ball bearings are captured. This cooperates with a translating ball nut 42 incorporating an eight circuit internal ball return path. The nut 42 embraces the shaft 40 and is fixed in the rear, left-hand end of the ram member 11 so that rotation of the shaft is translated into linear, axial displacement of the nut and hence of the ram member.

The mechanism includes a lock arrangement for positively retaining the ram 11 in the primary stow or retracted position, where the ram is at the left-hand end of its travel. The lock is located in the direct path of the torque as delivered from the bevel gearing 5 and incorporates a lost motion mechanism so that priority is given to locking or unlocking before drive is applied to the linear ball screw 40.

The mechanism includes a lock sleeve 50, which is slidable along the inside of the casing 1 and is urged forwardly, to the right, by a helical spring 51 in compression between a fixed plate 52 projecting inwardly from the casing and an inwardly-projecting ledge 53 at the rear end of the lock sleeve. A shallow collar 54 with inclined ends projects inwardly of the lock sleeve 50 a short distance from the forward end of the sleeve. In the stowed, retracted position shown in FIG. 2, the collar 54 engages the outer end 55 of the lock keys 56 in the form of radially-extending bolts slidable in respective, radially-extending recesses 57 formed in a fixed cylindrical support housing 58. Both the outer ends 55 and inner ends 59 of the lock keys 56 have bevelled or chamfered edges. Inward displacement of the lock keys 56 is limited by a follower 72 projecting forwardly under the lock key 56 as the locking extension sleeve 64 is driven to the right with the ball nut 42. In the stowed position shown in FIG. 2, the inner end 59 of the lock keys 56 are located in a groove 63 extending around the outside of a locking extension sleeve 64 projecting rearwardly and fixed at the rear end of the ball screw nut 42. The groove 63 has a flat floor, is wider (as viewed in the drawings, that is, in a direction parallel to the actuator axis) than the lock keys 56 and has inclined sides. It can be seen that, when the lock keys 56 are held in by the lock sleeve 50, no movement of the ram member 11 is possible even when very high external tension or compression loads are applied to the forward end 12 of the ram.

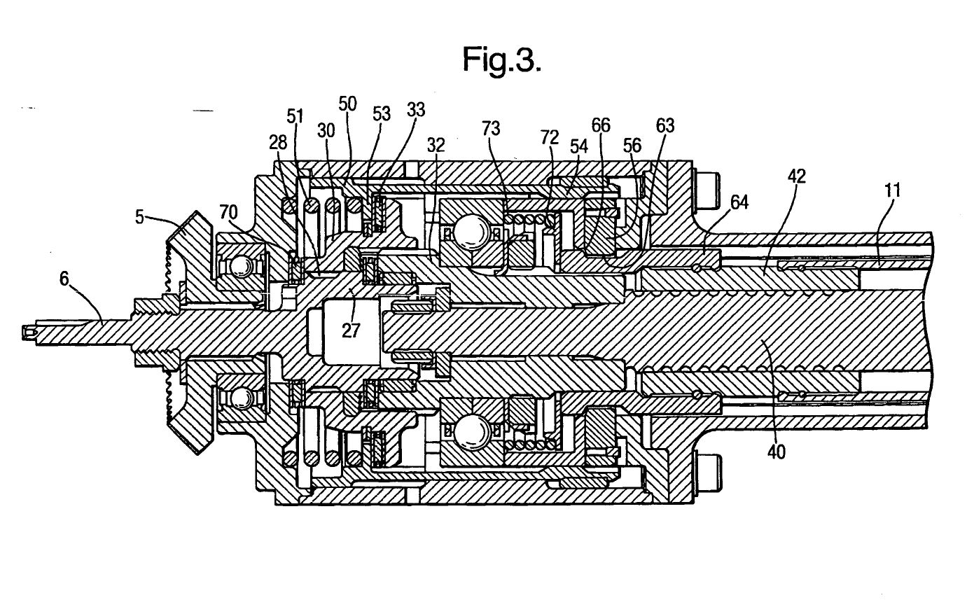

When the ram 11 is to be extended, as shown in FIG. 3, rotary drive is applied to the bevel gear 5 and to the drive shaft 6. Because of the lower mechanical force needed, the first few input rotations cause the drive sleeve 30 to be displaced rearwardly, to the left, along the Acme screw 28 and hence pulls the thrust bearing 33 with it. The left-hand face of the thrust bearing 33 engages the right-hand face of the ledge 53 on the lock sleeve 50 and thereby pulls this to the left against the action of the spring 51. It can be seen that this displaces the collar 54 away from the lock keys 56 and thereby opens a space above the lock keys. The lock sleeve 50 is, therefore, shifted axially by the lost motion drive sleeve 30 before the Acme ball screw 40 and nut 42 converts the rotary motion into linear motion of the ram 11.

Once the thrust bearing 33 has been driven fully along the Acme screw 28 it comes into contact with a thrust washer 70, which acts as an axial stop. All input torque is now automatically applied to the spline connection of the drive sleeve 30 and the output shaft 32, which drives the ball screw 40, ball nut 42 and ram member 11 forwardly, to extend the ram to the right.

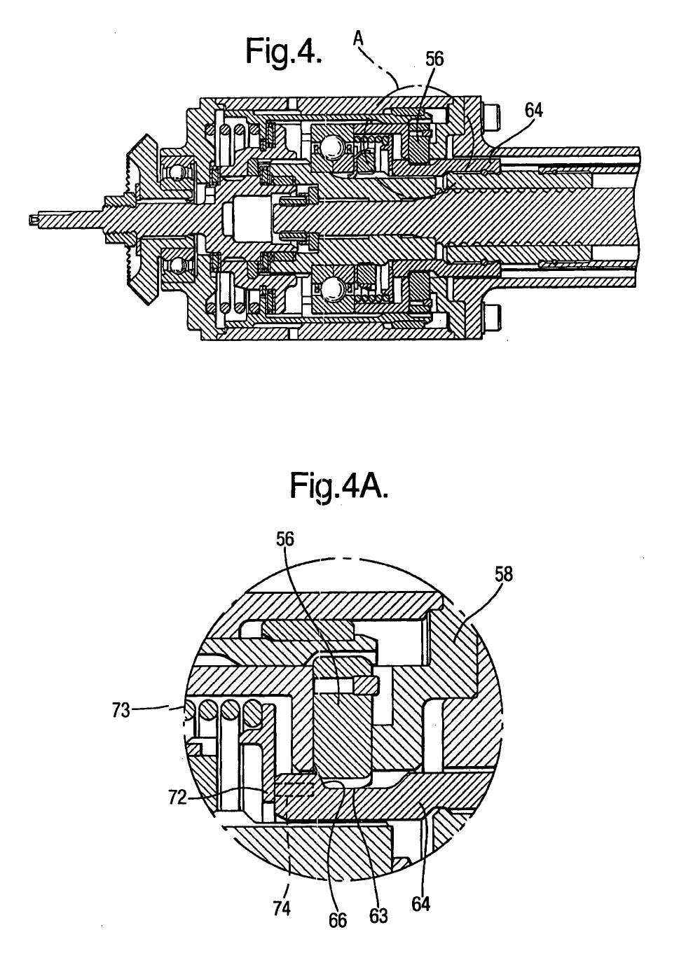

FIGS. 4 and 4A show that the locking extension sleeve 64 also moves forwardly, the inclined rear side 66 of the groove 63 engaging the bevelled rear edge of the lock keys 56 to drive them outwardly and disengage the lock mechanism. As the extension sleeve 64 moves forwardly it is followed by a follower 72 under the action of a helical spring 73. The follower 72 has a short, forwardly-projecting cylindrical wall 74 indicated by a broken, hidden line.

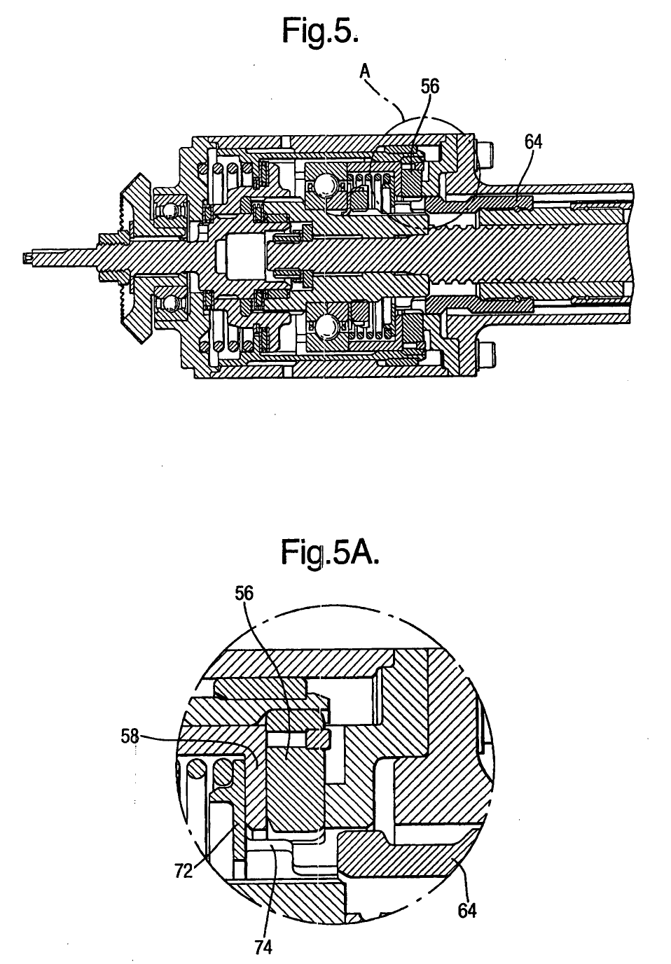

As the extension sleeve 64 moves to a more fully deployed position, as shown in FIGS. 5 and 5A, the follower 72 moves to its fully extended position in contact with the support housing 58, with the wall 74 projecting beyond the inner end of the lock keys 56 and thereby prevents them being displaced inwardly.

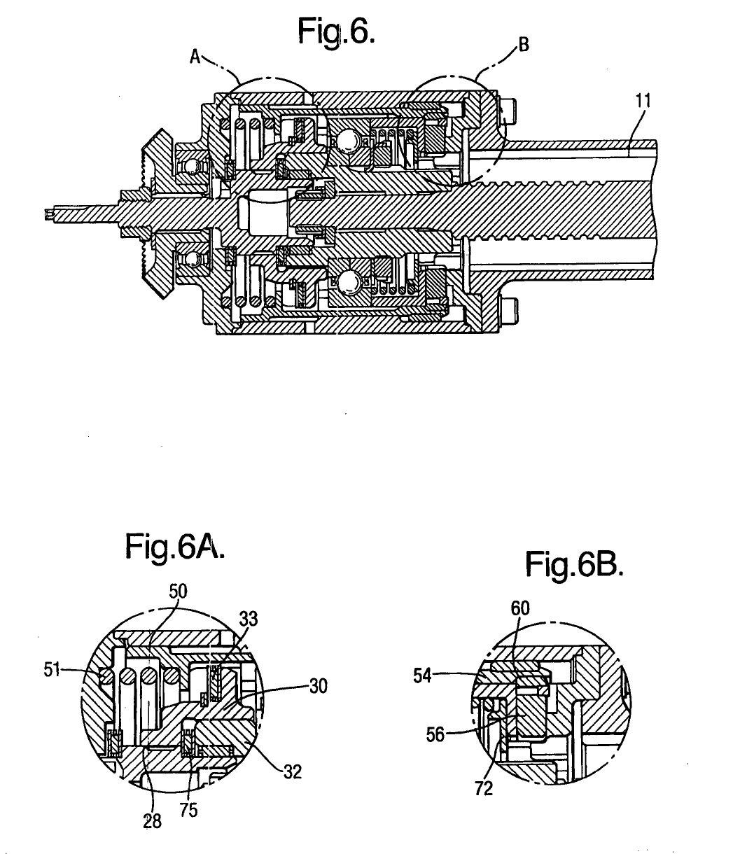

When rotation is applied to the input in the opposite sense, to cause the ram member 11 to stow or retract, as shown in FIGS. 6, 6A and 6B, this first causes the drive sleeve 30 and thrust bearing 33 to advance forwardly, to the right, along the Acme screw 28 to its full extent, as limited by engagement with a forward thrust washer 75. The spring 51 can now push the lock sleeve 50 forwardly until the incline on the forward end of its collar 54 engages the rear-facing chamfer 60 on the lock keys 56. This produces an inwardly-directed force vector acting on the lock keys 56 but their movement is prevented by the follower 72, which is still in the forward position.

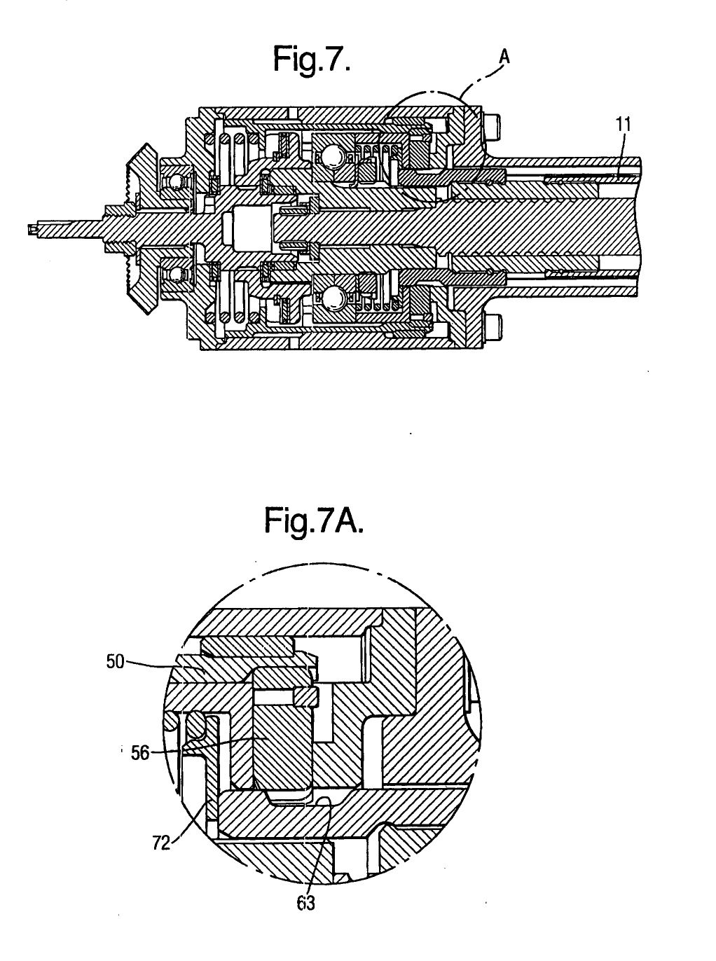

Continued rotation of the drive shaft 30 and the output shaft 32 causes the ram member 11 to be pulled inwardly until its extension sleeve 64 displaces the follower 72 rearwardly, as shown in FIGS. 7 and 7A, and its groove 63 moves into alignment with the lock keys 56. This allows the force vector between the lock sleeve 50 and the keys 56 to push them inwardly into the groove 63 and thereby lock the ram 11 in its stowed position.

The locking and unlocking processes are totally automatic and do not require any additional signals or devices. In the stowed position, the actuator is mechanically and positively locked. An optional proximity sensor can be used to sense the position of the lock sleeve 50 and provide a lock indication to the control logic circuit if desired. The lock keys cannot be disengaged by any external forces and allow uncontrolled movement of the actuator ram.

What I claim is:

1. An actuator comprising: a rotary input member, a linear output member, a mechanism for converting rotary motion of the input member to linear motion of the output member, a lock member displaceable from a first position in locking engagement with the linear output member to a second position out of locking engagement, and an arrangement for retaining the lock member in the first position until there is rotary motion of said input member.

2. An actuator according to claim 1, wherein said lock member is displaceable radially.

3. An actuator according to claim 1, wherein said retaining arrangement includes a second member, and wherein said second member is displaceable axially in response to rotation of said input member.

4. An actuator according to claim 1, wherein said lock member and said linear output member have cooperating inclined surfaces such that linear movement of said output member applies a radial force to said lock member.

5. An actuator according to claim 1, wherein said mechanism for converting rotary motion to linear motion includes a lead screw and nut mechanism.

6. An actuator according to claim 5, including a lost-motion coaxial drive sleeve arranged to couple said the rotary input member with said lead screw, and wherein said drive sleeve connects with said input member by cooperating threads on said input member and said drive sleeve such that rotation of the input member initially causes axial displacement of said drive sleeve before it causes rotation of said drive sleeve and of said lead screw.

7. An actuator according to claim 6, including a separate, axially-displaceable lock sleeve and wherein said drive sleeve cooperates with said lock sleeve to effect axial displacement of said lock sleeve when said drive sleeve is displaced axially.

8. An actuator according to claim 7, wherein said lock member is radially displaceable, and wherein said lock sleeve has an inner surface arranged to engage one end of said lock member such as to enable or prevent displacement of said lock member.

9. An actuator comprising a rotary input member, a linear output member and a mechanism for converting rotary motion of said input member to linear motion of said output member, wherein the actuator is arranged to lock said linear output member in a fixed position until there is rotary motion of said input member.

10. An actuator comprising a rotary input member, a linear output member, a mechanism for converting rotary motion of the input member to linear motion of the output member, and a lock mechanism displaceable from a locking state to a release state, wherein the actuator is arranged to displace the lock mechanism from the locking state to the release state when rotary motion is applied to said input member.
